(19) United States
(12) Patent Application Publication
(10) Pub. No.: US 2017/0181441 A1
(43) Pub. Date: Jun. 29, 2017

(54) KNEADING MACHINE FOR USE IN THE PROCESSING OF FOOD DOUGHS

(71) Applicant: Enodia S.r.l. Unipersonale, Molina di Malo (VI) (IT)

(72) Inventor: PIETRO SOTTORIVA, Marano Vicentino (VI) (IT)

(73) Assignee: Enodia S.r.l. Unipersonale, Molina di Malo (VI) (IT)

(21) Appl. No.: 15/383,285

(22) Filed: Dec. 19, 2016

(30) Foreign Application Priority Data
Dec. 23, 2015 (IT) 102015000087544

(51) Int. Cl. A21C 1/14; A21C 1/02; B01F 11/00

(52) U.S. Cl. CPC A21C 1/1405; B01F 11/0085; B01F 11/0097; A21C 1/02; A21C 1/1465; B01F 2215/0011

(57) ABSTRACT

A kneading machine for use in the processing of food dough, to be used in bakeries, breadstick factories, and the pastry and confectionery industry as well as for domestic use. The kneading machine is of the mechanical arm type wherein the kneading tool (10) completes a trajectory which extends more than half and up to the entire diameter of the tub (V) containing the dough. The working end or terminal part of the kneading tool includes a shaped kneading implement (9) immersed in the mass of dough (P) both in the outward travel and in the return travel and acts on the entire mass of dough.

### FIELD OF THE INVENTION

The present invention relates to a kneading machine for use in the processing of food dough, of the mechanical arm type, for use in commercial and domestic operations.

### BACKGROUND OF THE INVENTION

As is well known, kneading machines used in the food industry consist of machines for mixing ingredients, generally consisting of water, flour, yeast and salt, with the addition of other secondary foods, as well as for the blending thereof, to obtain a homogeneous mass of dough, intended for subsequent processes and final baking.

All kneading machines consist of a fixed structure, containing the mechanical drive elements of the kneading tools and, optionally, also a tub containing the ingredients to be mixed, as well as a kneading or a pair of kneading tools having a shaped implement at the end thereof for mixing the ingredients, and an electrical control panel. In relation to the type of kneading tool used, the kneading machines are divided into the following types:
spiral kneaders and fork kneaders, wherein the kneading tool consists of a spiral or a fork rotating about a longitudinal axis;
planetary kneaders, wherein the tool consists of a whip, provided with a planetary motion about a vertical axis;
mechanical arm kneaders, wherein a pair of kneading tools is mounted on an articulated element, which confers a roto-translation movement to the tools in a vertical plane.

In practice, in kneading machines with mechanical arms of the known type, used in bakeries, breadstick factories, the pastry industry and the confectionery industry, the two kneading tools each work on one half of the tub and only the rotation of the tub allows the whole mass of dough to be processed by both kneading tools.

Patent documents FR393466A, DE199398C, DE180688C, FR11823E and DE257964C describe kneading machines with mechanical arms which provide that the kneading tool completes a trajectory which extends beyond half and up to the entire diameter of the tub in which the dough is placed, so that the terminal part or end of the tool having the shaped kneading implement which is immersed in the mass of dough, both in the outward travel and in the return travel acts on the entire mass of dough.

### SUMMARY OF THE INVENTION

The object of the present invention is to provide a kneading machine with mechanical arms which allows performing the mixing and blending of the dough with better results than obtainable with similar machines of known type.

In particular, the object of the invention is to provide a kneading machine with mechanical arms which ensures an optimal oxygenation of the dough, a condition that is required also in domestic kneaders where the tub, with a load of dough that ranges from a minimum of 2.5 kg to a maximum of 7 kg, is removable and, as a rule, not rotating.

In order to ensure the maximum mixing and blending action of the entire mass of dough, the kneading machine according to the invention is provided with two kneading tools as described above, which operate on two parallel vertical planes with concordant or mutually opposing directions.

### BRIEF DESCRIPTION OF THE DRAWINGS

The features of the invention will be better understood by the description of a possible embodiment thereof, given only by way of non-limiting example, with the aid of the accompanying drawings, in which:

FIG. 1 is a schematic view of a kneading machine provided with the innovative kneading tool of the present invention;

FIG. 2 and FIG. 3 show two successive steps, the outward and return step, respectively, of the kneading tool of FIG. 1;

FIG. 4 is an elevational view of a kneading machine of the present invention provided with two opposing kneading tools;

FIG. 5 is a plan view of the kneading machine shown in FIG. 4.

### DETAILED DESCRIPTION OF THE PREFERRED EMBODIMENT

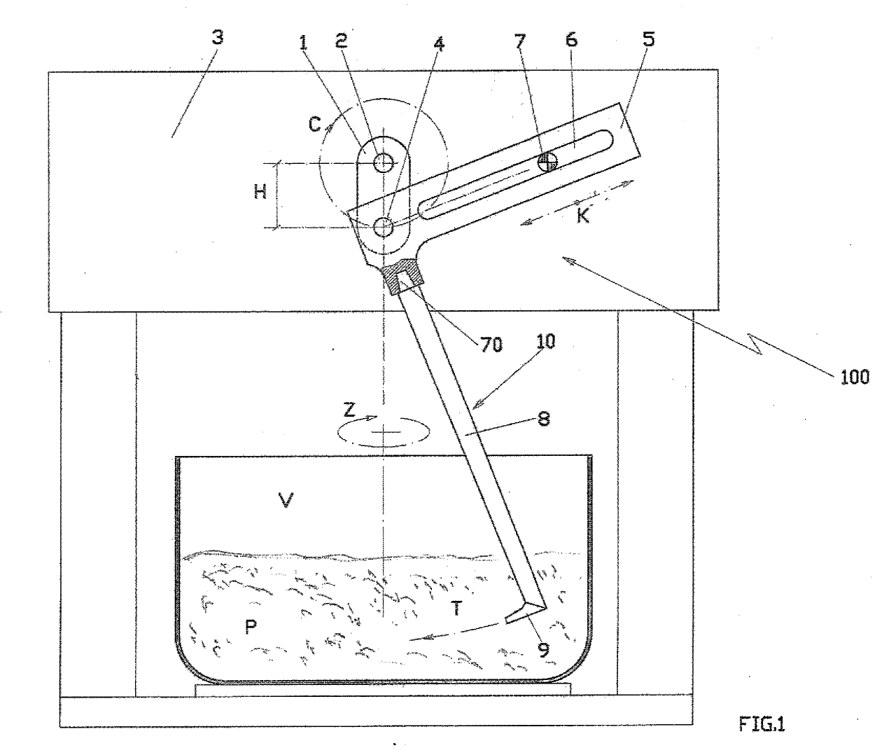

As shown in FIG. 1, the articulated system, generally designated with reference numeral 100, imparts a translational/oscillating movement to kneading tool 10 in a vertical plane. The system consists of a crank 1, rotating 360° around an end drive pin 2 mounted on a support plate 3, while a connection pin 4 is provided at the other end of crank 1, hingedly connected to the end of an extended bar or arm 5, in which a slot 6 is formed, which is engaged with a fixed pin 7 protruding from the support plate. The extended arm 8 of kneading tool 10 is connected to bar 5.

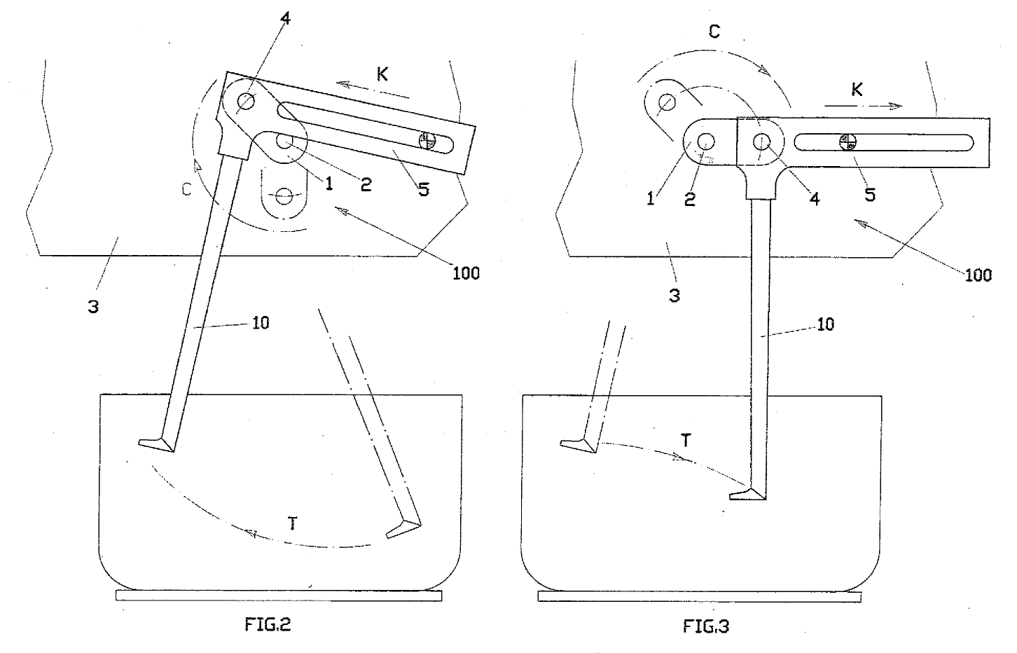

Operatively, as can be seen in succession in FIGS. 1-3, the 360° circular rotation (trajectory C) of crank 1 around pin 2 pulls, by means of connection pin 4, bar 5 which, being engaged to slide with slot 6 on pin 7, performs a reciprocating movement of roto/translation on fixed pin 7 (arrow K) so that the entire kneading tool 10 assumes a translational/oscillating movement, which allows the shaped kneading implement 9 at the end of tool 10, which is immersed in the mass of dough P, to perform an outward/return travel, with trajectory T substantially elliptical and extending up to the entire diameter of tub V, necessary to achieve the mixing and blending action of the entire mass of dough.

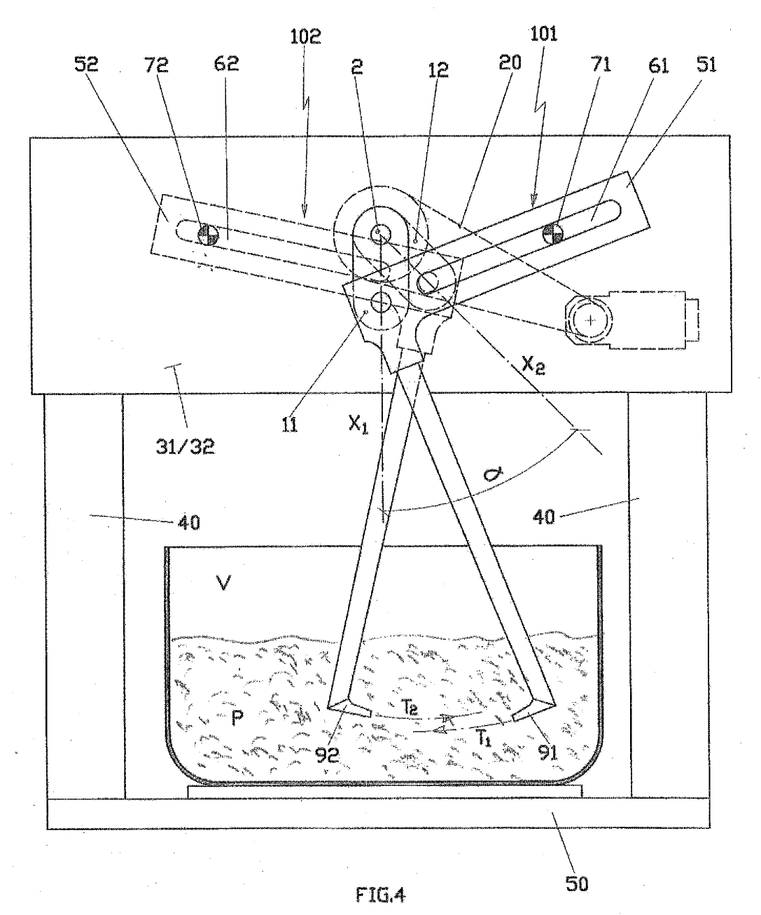

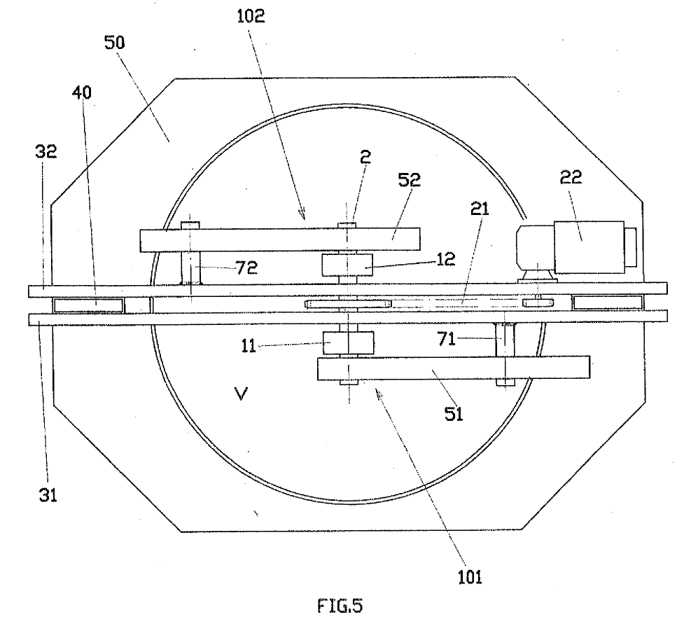

Constructively, as seen in FIGS. 4 and 5, a preferred embodiment of the kneading machine with mechanical arms according to the present invention provides for the use of two articulated systems 101 and 102, arranged mutually opposed to each other. The two cranks 11 and 12 of the respective systems are keyed to the same drive pin 2, while bars 51 and 52 have their corresponding slots 61 and 62 respectively engaged with fixed pins 71 and 72, protruding from the two corresponding support plates 31 and 32. Support plates 31 and 32 are supported by the vertical uprights 40 extending from a machine base 50, where tub V is positioned, optionally provided with a rotation motion as well (arrow Z, FIG. 1), by means of a conventional system (not shown).

Drive pin 2 is rotated by means of a kinematic control 20 consisting of the endless chain transmission 21, driven by motor 22, arranged on one of the two support plates 31 or 32. As shown in FIG. 5, motor 22 is attached to support plate 32.

In practice, as seen in FIG. 4, with the use of the two articulated systems 101 and 102 according to the invention it is possible to simultaneously cause the two kneading tools 10, and more precisely, the end shaped implements 91 and 92, to have two complete trajectories T₁ and T₂ having the same or, as depicted, mutually opposing directions, which allows a better mixing and blending action of the dough.

Moreover, the present invention provides that in order to better adapt the movement parameters of tool 10, such as the change of tool speed and the change of trajectory of the end shaped kneading implement 9 at the end of tool 10, to the physical characteristics of dough P, to ensure good oxygenation thereof without excessive heating, even at high working speed, it is possible to alter the distance H (see FIG. 1) between drive pin 2 and connection pin 4 of crank 1. It is also possible to vary the angle α (alpha) between the longitudinal axis X₁ of crank 11, defined between drive pin 2 and the connection pin to elongated bar 51, and the longitudinal axis X₂ of crank 12, defined between drive pin 2 and the connection pin to elongated bar 52, so that cranks 51 and 52 can be mutually aligned with respect to each other on drive pin 2 or mutually inclined with respect to each other on drive pin 2 in order to better adapt the movement parameters of the kneading tools advantageously.

Finally, the invention provides that kneading tool 10 may be removably applied on bar 5 by means, for example, of a rapid attack or quick disconnect for connection 70.

The present invention, which has proved particularly advantageous in the production of kneading machines with mechanical arms of the household type, used in the processing of soft dough to make, for example, bread dough, may take different forms and aspects than those illustrated and described without prejudice to its essential features, which must not, however, depart from the scope of the patent, being defined by the following claims.

What is claimed is:

1. In a mechanical arm kneading machine for mixing and blending food dough wherein a first elongated kneading tool is mounted to a first articulated system which imparts a movement to said tool whereby a shaped kneading implement mounted at a working end of said tool and immersed in a mass of dough to be processed performs the necessary actions of mixing and blending the dough contained in a tub (V), said first elongated kneading tool (10) being adapted to have a trajectory so that the shaped kneading implement (9) at the working end of said first elongated kneading tool (10) and immersed in the mass of dough (P), acts on the entire mass of dough (P),
the improvement comprising wherein said first articulated system imparts to said first elongated kneading tool (10) a translational/oscillating movement in a first vertical plane, said first articulated system comprising a first crank (1) fixedly mounted at a first end for 360° rotation about an axis of a drive pin (2) and having a connection pin (4) at a second end hingedly connected to an end of a first elongated bar (5) having a longitudinal slot (6) therein, said longitudinal slot (6) slidingly engaging a first fixed pin (7) extending from a support of said machine, said first elongated kneading tool (10) including an extending arm (8) connected to said first elongated bar (5).

2. The kneading machine according to claim 1, wherein the 360° rotational movement of said first crank (1) about the axis of said drive pin (2) moves said first elongated bar (5) by means of said hinged connected pin (4) and the sliding engagement of said slot (6) with respect to said first fixed pin (7) in a reciprocating movement of roto/translation relative to said first fixed pin (7) whereby said first elongated kneading tool (10) performs a translation/oscillating movement so that said shaped kneading implement (9) has an outward/return travel with a substantially elliptical trajectory (T) extending to the entire diameter of the tub (V) so as to achieve the mixing and blending action of the mass of dough (P).

3. The kneading machine according to claim 1, comprising a second kneading tool mounted to a second articulated system which imparts a movement to said second kneading tool, having a shaped kneading implement mounted at a working end of said second kneading tool and immersed in the mass of dough (P) contained in the tub (V), in a second vertical plane parallel to the first vertical plane of movement of said first kneading tool (10), said first and second articulated systems being mutually opposed, said second articulated system comprising a second crank fixedly mounted at a first end for 360° rotation about the axis of said drive pin (2) and having a connection pin at a second end hingedly connected to an end of a second elongated bar having a longitudinal slot therein, said longitudinal slot of said second elongated bar slidingly engaging a second fixed pin extending from said support of said machine, said second elongated kneading tool including an extending arm connected to said second elongated bar.

4. The kneading machine according to claim 3, wherein the 360° rotational movement of said second crank about the axis of said drive pin (2) moves said second elongated bar by means of said hinged connection pin of said second elongated bar and the sliding engagement of said slot of said second elongated bar with respect to said second fixed pin in a reciprocating movement of roto/translation relative to said second fixed pin whereby said second elongated kneading tool performs a translational/oscillating movement so that said shaped kneading implement mounted on the working end of said second elongated kneading tool has an outward/return travel with a substantially elliptical trajector (T₂) extending to the entire diameter of the tub (V).

5. The kneading machine according to claim 4, which further comprises a knematic control (20) including an endless chain transmission (21) driven by a motor (22) mounted on the support of said machine for driving said drive pin (2).

6. The kneading machine according to claim 4, wherein said first and second articulated systems are configured so that said first and second elongated kneading tools and the respective shaped kneading implements connected thereto simultaneously complete respective trajectories (T₁, T₂) in coincidence with each other.

7. The kneading machine according to claim 4, wherein said first and second articulated systems are configured so that said first and second elongated kneading tools and the respective shaped kneading implements connected thereto simultaneously complete respective trajectories (T₁, T₂) in mutual opposition to each other.

8. The kneading machine according to claim 1, wherein the distance (H) between said drive pin (2) and said connection pin (4) of said first crank (1) can be altered so that the trajectory (T) of the shaped kneading implement (9) at the working end of said first elongated kneading tool (10) can be varied.

9. The kneading machine according to claim 3, wherein the angle (α) between a longitudinal axis of said first crank, defined between said drive pin (2) and said connection pin of said first crank, and a longitudinal axis of said second crank, defined between said drive pin (2) and said connection pin of said second crank, can be altered so that said first and second cranks can be mutually aligned with respect to each other on said drive pin (2) or mutually inclined with respect to each other on said drive pin (2).

10. The kneading machine according to claim 1, wherein said extending arm (8) of said first elongated kneading tool (10) is removably connected to said first elongated bar (5) by a quick disconnect (70).

11. The kneading machine according to claim 1, wherein said tub (V) containing the mass of dough (2) is configured to rotate with respect to said machine.
